(19) United States
(12) Patent Application Publication
(10) Pub. No.: US 2007/0068713 A1
(43) Pub. Date: Mar. 29, 2007

(54) Automobile driving system and automobile

(75) Inventors: Akiyoshi Komura, Hitachi (JP); Kazumasa Ide, Hitachiohta (JP); Takao Ishikawa, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 11/528,330

(22) Filed: Sep. 28, 2006

(30) Foreign Application Priority Data
Sep. 29, 2005 (JP) 2005-283237

(51) Int. Cl. B60L 11/18; H01M 8/04

(52) U.S. Cl. 180/65.3; 429/34

(57) ABSTRACT

A highly-efficient and small-sized driving system which is suitable for use in an automobile using hydrogen as fuel, e.g., a hydrogen-engine hybrid vehicle or a fuel cell vehicle. In a hybrid automobile comprising a high-pressure hydrogen tank, a hydrogen engine using hydrogen as fuel, and a rotating device for generating or regenerating automobile driving energy, at least a part of hydrogen gas supplied from the high-pressure hydrogen tank is supplied to the hydrogen engine after being utilized to cool the rotating device.

### BACKGROUND OF THE INVENTION

1. Field of the Invention

The present invention relates to an automobile driving system for use in an automobile that utilizes hydrogen as fuel, and to an automobile employing the driving system.

2. Description of the Related Art

Recently, the problems of global warming and resource exhaustion have become more apparently obvious and interests on effective utilization of energy have been increased. In point of global warming, particularly, Kyoto Protocol to the United Nations Framework regarding a cut target of CO₂ came into effect. This means that Japan is required to cut the CO₂ exhaust amount by 6% on the basis of the amount in 1990 during a period from 2008 to 2012. Looking at the field of transportations, the amount of energy consumed in that field occupies about ¼ of the total energy consumption in Japan and petroleum consumption in that field reaches near 40% of the total consumption in Japan. Therefore, more efficient utilization of fuel and the use of cleaner fuel in the field of transportations are very important from the viewpoint of environment protection.

Against such background, automobile makers have intensively conducted developments of hybrid cars from the viewpoint of more efficient utilization of fuel and engine vehicles using hydrogen as fuel and fuel cell vehicles from the viewpoint of fuel cleaning.

An automobile employing a hydrogen engine as a driving source is disclosed in, e.g., JP-A-2001-258105 (Patent Document 1). Abstract of Patent Document 1 discloses a hybrid vehicle employing a hydrogen engine and a motor as driving sources, wherein hydrogen stored in a hydrogen reservoir is supplied as fuel to the hydrogen engine for driving the hydrogen engine, and the hydrogen stored in the hydrogen reservoir is also supplied to a fuel cell such that electric power generated by the fuel cell is used as a motor driving power source.

### SUMMARY OF THE INVENTION

FIG. 7 shows a typical system arrangement of a hybrid vehicle using hydrogen as fuel. The system arrangement of the hybrid vehicle, shown in FIG. 7, is called parallel type in which an engine and a rotating device are arranged in parallel for driving of wheels. More specifically, hydrogen from a high-pressure hydrogen tank 1 is supplied as fuel to drive an engine 3, while a rotating device 2 is utilized as a generator for regeneration of motive power from wheels 5 to store electric power in a battery 4. The rotating device 2 is also utilized as a motor, as required, to drive the wheels 5. Note that a power converter for converting AC power from the rotating device 2 to DC power and supplying the DC power to the battery 4 or for converting DC power from the battery 4 to AC power and supplying the AC power to the rotating device 2 is omitted in FIG. 7. The rotating device 2 is generally cooled by using open air, and the open air is taken into the rotating device 2 by a fan included in the rotating device. In that case, because the body size of the rotating device 2 is restricted from the viewpoint of an air cooling characteristic, there is a limitation in reducing the size of the rotating device. Further, the temperature of open air always varies depending on the place of use, the time of year (season), etc., and the temperature of the rotating device also changes correspondingly. In particular, when the hybrid vehicle requires to be driven in the place and the season where the rotating device 2 is exposed to high temperatures, the body size of the rotating device must be designed in relatively larger dimensions with a sufficient allowance, taking into account such a level of high temperatures.

With the view of overcoming the above-described situations, the present invention provides an automobile driving system and a hybrid automobile including the automobile driving system, which comprises a high-pressure hydrogen tank, a hydrogen engine using hydrogen as fuel, and a rotating device for generating or regenerating automobile driving energy, wherein at least a part of hydrogen gas supplied from the high-pressure hydrogen tank is supplied to the hydrogen engine after being utilized to cool the rotating device.

According to the present invention, since the rotating device is cooled by utilizing the hydrogen gas supplied from the high-pressure hydrogen tank to the hydrogen engine, it is possible to efficiently cool the rotating device and to reduce the size of the automobile driving system. With the size reduction of the automobile driving system, an automobile having a larger compartment space can be provided.

### BRIEF DESCRIPTION OF THE DRAWINGS

FIG. 1 is a system block diagram showing a first embodiment of the present invention;

FIG. 2 is a system block diagram showing a second embodiment of the present invention;

FIG. 3 is a system block diagram showing a third embodiment of the present invention;

FIG. 4 is a system block diagram showing a fourth embodiment of the present invention;

FIG. 5 is a system block diagram showing a fifth embodiment of the present invention;

FIG. 6 is a system block diagram showing a sixth embodiment of the present invention;

FIG. 7 is a system block diagram showing the related art;

FIG. 8 is a system block diagram showing a seventh embodiment of the present invention; and

FIG. 9 is a system block diagram showing an eighth embodiment of the present invention.

### DESCRIPTION OF THE PREFERRED EMBODIMENTS

An automobile driving system using hydrogen as fuel, according to the present invention, will be described in detail below in connection with several embodiments shown in the drawings.

### First Embodiment

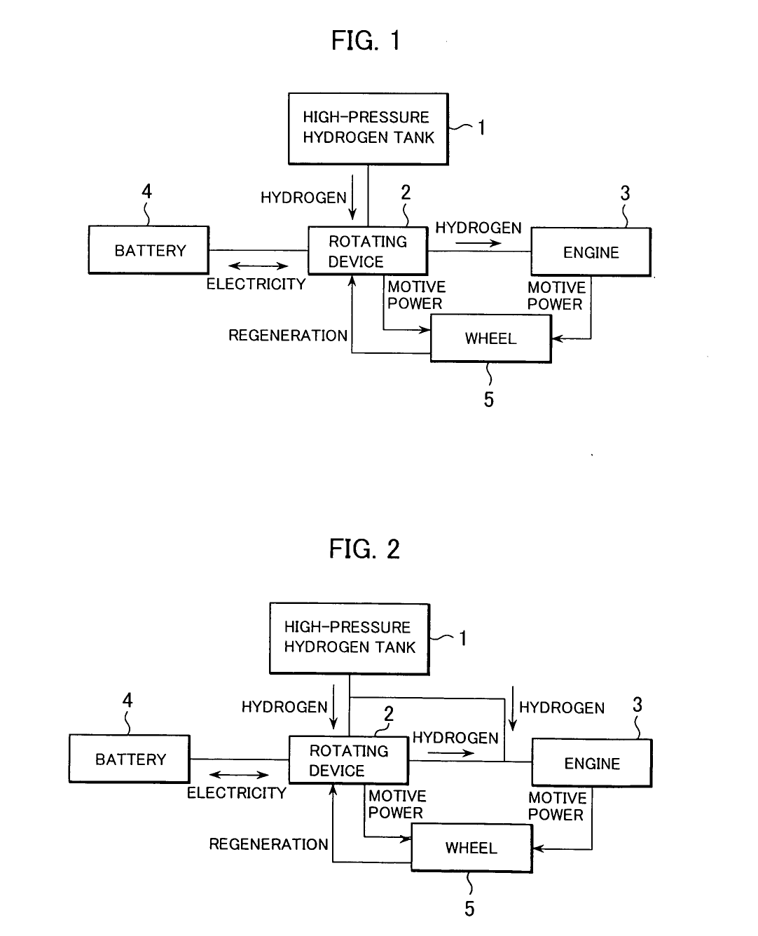

FIG. 1 is a system block diagram showing a first embodiment of the present invention. FIG. 1 represents a parallel hybrid vehicle using hydrogen as fuel, which comprises a high-pressure hydrogen tank 1, a hydrogen engine 3 using hydrogen as fuel, a rotating device 2 for generating or regenerating automobile driving energy, and a battery 4 for storing electric power. The hydrogen engine 3 and the rotating device 2 are arranged in parallel for driving of wheels 5. A power converter for converting AC power from the rotating device 2 to DC power and supplying the DC power to the battery 4 or for converting DC power from the battery 4 to AC power and supplying the AC power to the rotating device 2 is omitted in FIG. 1. Further, a flow adjusting valve is generally disposed in the outlet side of the high-pressure hydrogen tank 1, but it is also omitted in FIG. 1.

Hydrogen gas supplied from the high-pressure hydrogen tank 1 is supplied as fuel to the hydrogen engine 3 through the rotating device 2. On that occasion, the hydrogen gas is utilized as a coolant for cooling the rotating device 2. In other words, by using the hydrogen gas having a good cooling characteristic as the coolant, higher efficiency and smaller size of the rotating device 2 can be realized in comparison with the related art using air (open air) as the coolant for cooling the rotating device. Also, because the hydrogen gas is supplied under high pressure to the rotating device 2, a fan for transferring the coolant, which is usually necessary in the related art, is no longer required, thus resulting in even higher efficiency and even smaller size of the rotating device 2. Further, because the hydrogen gas is supplied through the rotating device 2 to the engine 3 after recovering a part of heat generated by the rotating device, energy required for warming up the engine can be cut in comparison with the case of supplying the hydrogen gas to the engine directly from the high-pressure hydrogen tank 1.

While the first embodiment has been described above, by way of example, in connection with the parallel hybrid vehicle, similar advantages can also be obtained in other types of hybrid vehicles, e.g., the series type, by supplying the hydrogen gas from the high-pressure hydrogen tank to the engine after utilizing the hydrogen gas to cool the rotating device.

Further, while the first embodiment has been described above, by way of example, in connection with the case using the high-pressure hydrogen tank as a hydrogen generating source, similar advantages can also be obtained by employing, as the hydrogen generating source, a high-pressure tank with a hydrogen storage alloy instead of the high-pressure hydrogen tank.

In addition, similar advantages can also be obtained by using, as the hydrogen storing method, any of other suitable methods utilizing liquid hydrogen, a hydrogen storage alloy, organic hydrides, etc. In that case, however, because hydrogen gas cannot be supplied under high pressure to the rotating device unlike the case using the high-pressure hydrogen tank, it is required to install a coolant driving fan at an appropriate position in a hydrogen line, or to incorporate the coolant driving fan in the rotating device. Anyway, an advantage is obtained in that one of the coolant driving fan in the hydrogen line and the coolant driving fan in the rotating device can be omitted.

### Second Embodiment

FIG. 2 is a system block diagram showing a second embodiment of the present invention. This second embodiment differs from the first embodiment in that a part of the hydrogen gas supplied from the high-pressure hydrogen tank 1 is utilized to cool the rotating device 2 and the remaining hydrogen gas is merged with the hydrogen gas after cooling the rotating device and then utilized as fuel for the hydrogen engine 3. Such an arrangement requires a flow adjusting valve to be disposed in one or both of hydrogen lines, but the flow adjusting valve is omitted in FIG. 2.

This second embodiment can also provide similar advantages to those in the first embodiment.

### Third Embodiment

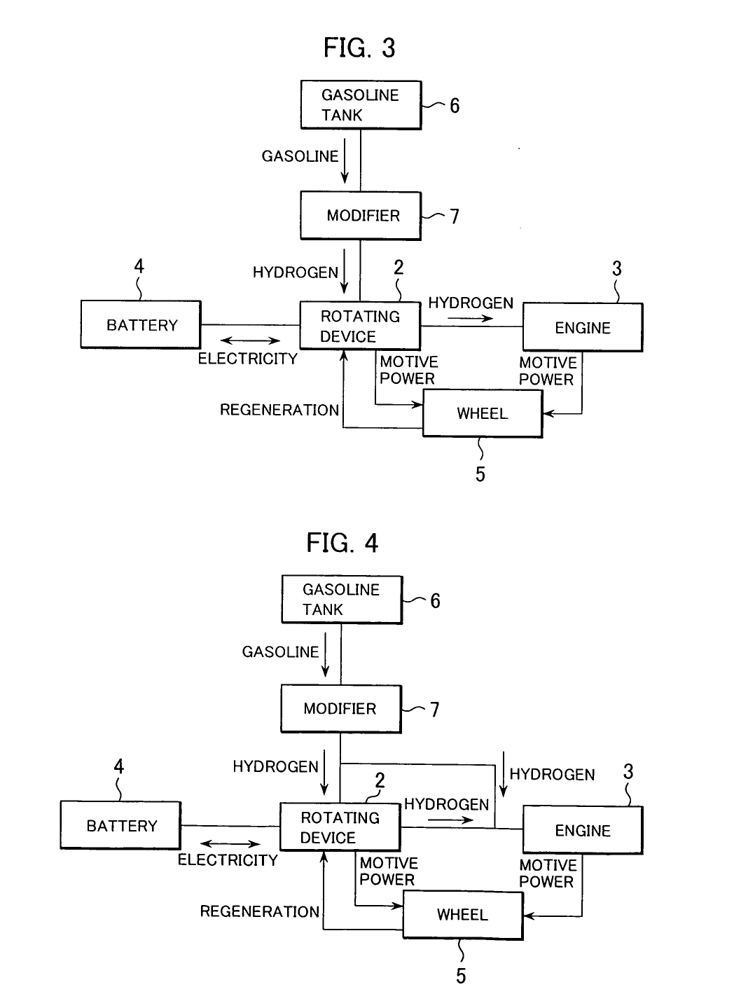

FIG. 3 is a system block diagram showing a third embodiment of the present invention. This third embodiment differs from the first embodiment in that, instead of the high-pressure hydrogen tank, a modifier 7 for converting gasoline supplied from a gasoline tank 6 to hydrogen is employed as the hydrogen generating source.

This third embodiment can also provide similar advantages to those in the first embodiment. In the third embodiment, however, because hydrogen gas cannot be supplied under high pressure to the rotating device 2 unlike the case using the high-pressure hydrogen tank, it is required to install a coolant driving fan at an appropriate position in a hydrogen line, or to incorporate the coolant driving fan in the rotating device. Anyway, an advantage is obtained in that one of the coolant driving fan in the hydrogen line and the coolant driving fan in the rotating device can be omitted.

While the third embodiment has been described above, by way of example, as using gasoline as fuel, similar advantages can also be obtained in the case using other types of combustible fuel, e.g., another fossil fuel or bio fuel.

### Fourth Embodiment

FIG. 4 is a system block diagram showing a fourth embodiment of the present invention. This fourth embodiment differs from the third embodiment in that a part of hydrogen gas supplied through the modifier 7 after conversion of gasoline from the gasoline tank 6 is utilized to cool the rotating device 2 and the remaining hydrogen gas is merged with the hydrogen gas after cooling the rotating device and then utilized as fuel for the hydrogen engine 3.

The fourth embodiment can also provide similar advantages to those in the third embodiment.

### Fifth Embodiment

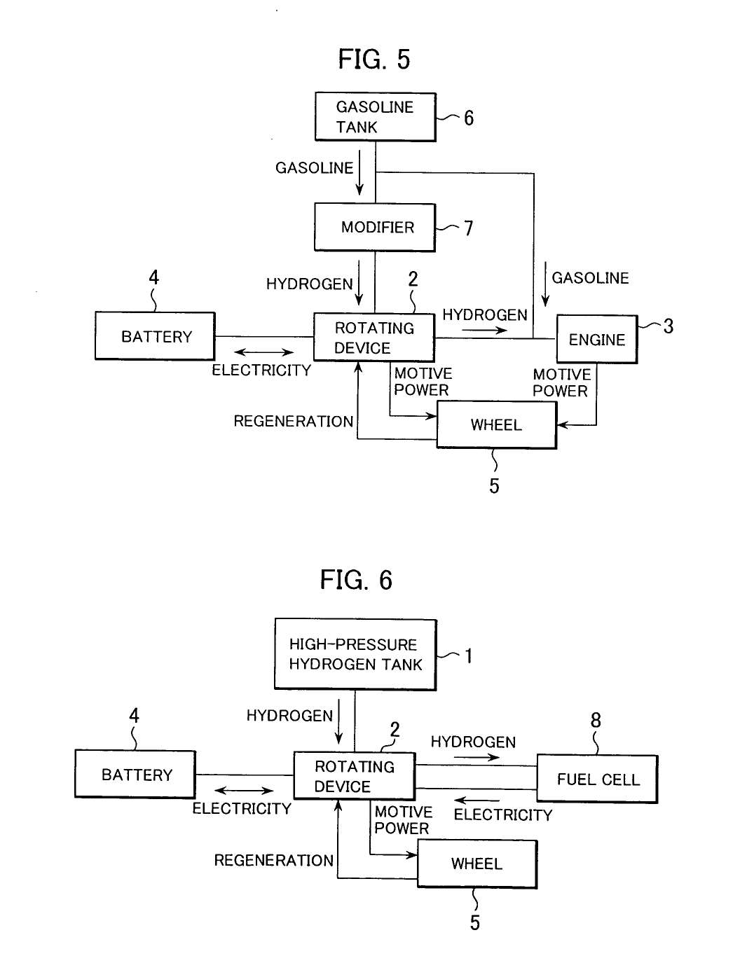

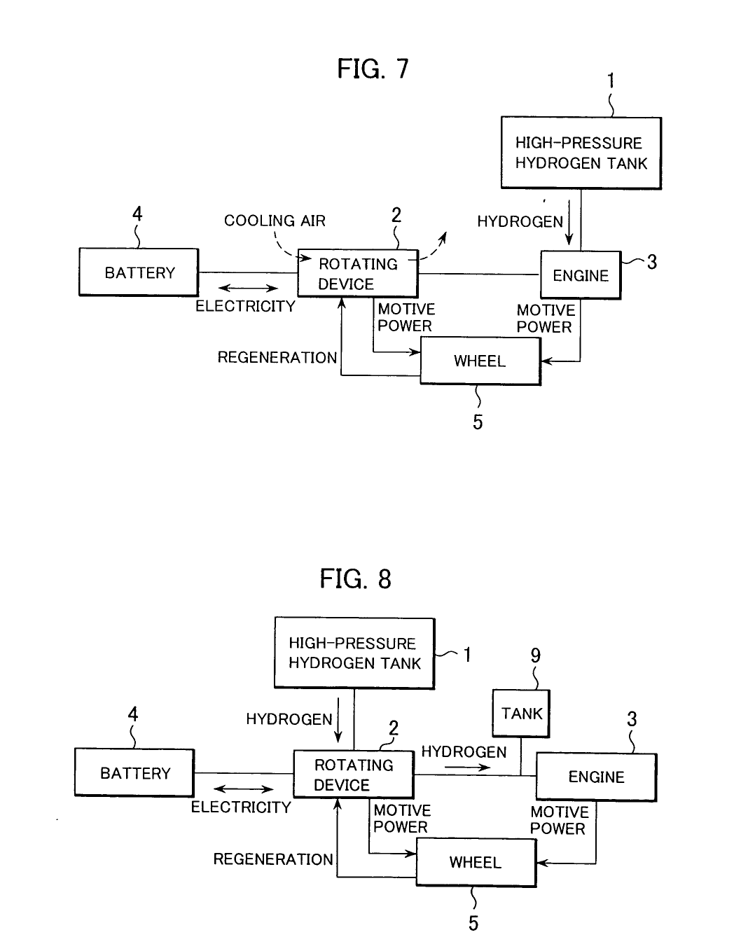

FIG. 5 is a system block diagram showing a fifth embodiment of the present invention. This fifth embodiment differs from the third embodiment in that a part of the gasoline supplied from the gasoline tank 6 is converted by the modifier 7 to hydrogen which is utilized to cool the rotating device 2, and the remaining gasoline is merged with the hydrogen gas after cooling the rotating device and then utilized as fuel for the hydrogen engine 3.

The fifth embodiment can also provide similar advantages to those in the third embodiment.

### Sixth Embodiment

FIG. 6 is a system block diagram showing a sixth embodiment of the present invention. FIG. 6 represents a fuel cell vehicle using hydrogen as fuel, which comprises a high-pressure hydrogen tank 1, a fuel cell 8 using hydrogen as fuel, a rotating device 2 for generating or regenerating automobile driving energy, and a battery 4 for storing electric power. Electricity generated by the fuel cell 8 is not only utilized as a motive power source to drive the rotating device 2 as a motor, thereby driving wheels 5, but also stored in the battery 4 depending on situations. A power converter for converting AC power from the rotating device 2 to DC power and supplying the DC power to the battery 4 or for converting DC power from the battery 4 or the fuel cell 8 to AC power and supplying the AC power to the rotating device 2 is omitted in FIG. 6. Practical examples of the fuel cell include PEFC (Polymer Electrolyte Fuel Cell), PAFC (Phosphor Acid Fuel Cell), MCFC (Molten Carbonate Fuel Cell), and SOFC (Solid Electrolyte Fuel Cell).

Hydrogen gas supplied from the high-pressure hydrogen tank 1 is supplied as fuel to the fuel cell 8 through the rotating device 2. On that occasion, the hydrogen gas is utilized as a coolant for cooling the rotating device 2. In other words, by using, as the coolant, the hydrogen gas having a good cooling characteristic, higher efficiency and smaller size of the rotating device 2 can be realized in comparison with the related art using air (open air) as the coolant for cooling the rotating device. Also, because the hydrogen gas is supplied under high pressure to the rotating device 2, a fan for driving the coolant, which is usually necessary in the related art, is no longer required, thus resulting in even higher efficiency and even smaller size of the rotating device 2. In the fuel cell, fuel temperature requires to be increased to the operating temperature (e.g., 70-90° C. in PEFC and 800-1000° C. in SOFC). However, because the hydrogen gas is supplied through the rotating device 2 to the fuel cell 8 after recovering a part of heat generated by the rotating device, energy required for warming up the fuel can be cut in comparison with the case where the hydrogen gas is supplied to the fuel cell directly from the high-pressure hydrogen tank 1.

The automobile driving system using the fuel cell can also be practiced in other embodiments in which the fuel cell is employed instead of the hydrogen engine in each of the second (FIG. 2) to fifth (FIG. 5) embodiments. Though not described here in detail, each of those embodiments can also provide similar advantages.

### Seventh Embodiment

FIG. 8 is a system block diagram showing a seventh embodiment of the present invention. This seventh embodiment differs from the first embodiment in that a hydrogen tank 9 is installed in a hydrogen line between the rotating device 2 and the hydrogen engine 3. In the hybrid vehicle, when the rotating device 2 is driven by electricity from the battery 4 while the hydrogen engine 3 is stopped, i.e., when driving energy is generated only by the rotating device, the hydrogen gas after cooling the rotating device can be temporarily stored in the hydrogen tank 9 by stopping the hydrogen supply to the engine. If the hydrogen tank 9 includes a motive power source (e.g., a fan or a pump) for transferring hydrogen, it can more effectively store the hydrogen gas. The hydrogen gas temporarily stored in the hydrogen tank 9 is supplied as fuel when the engine is started. As a result, it is possible to effectively utilize the hydrogen that is discharged in the first embodiment without being utilized.

### Eighth Embodiment

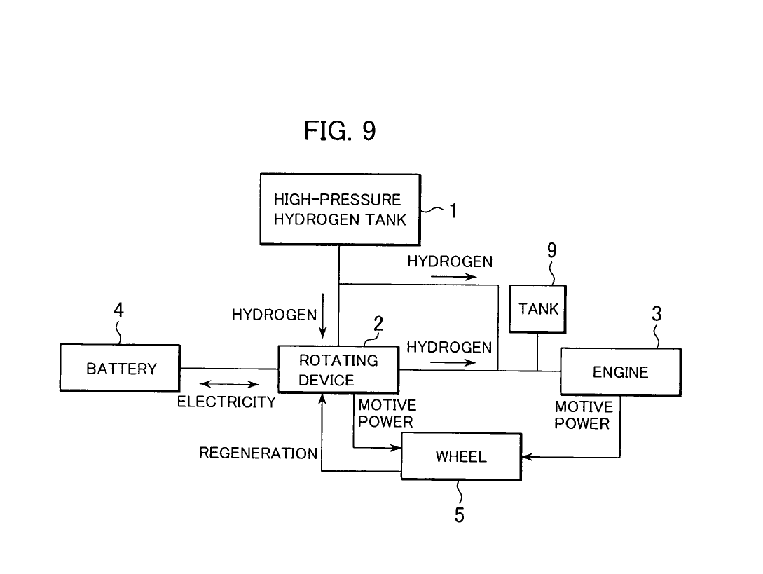

FIG. 9 is a system block diagram showing an eighth embodiment of the present invention. This eighth embodiment differs from the second embodiment in that a hydrogen tank 9 is installed in a hydrogen line between the rotating device 2 and the hydrogen engine 3. This eighth embodiment can also provide similar advantages to those in the seventh embodiment.

According to the present invention, the hydrogen gas in the high-pressure hydrogen tank is utilized to cool the rotating device. As compared with air, hydrogen has a superior cooling characteristic (calculating thermal conductivity under the same condition (i.e., pressure of 1 atm and temperature of 300 K), for example, the thermal conductivity of hydrogen is 84.8 W/(m·k) and the thermal conductivity of air is 57.8 W/(m·k) when the Dittus-Boelter equation for calculating forced-convection turbulent thermal conductivity is used on the assumption of typical dimension of 10 mm and flow velocity of 10 m/s). Therefore, higher efficiency and smaller size of the rotating device can be realized. Further, because the pressure and temperature in the high-pressure hydrogen tank are maintained in a comparatively stable state, there is no need of considering the temperature of air (open air) for cooling the rotating device unlike the case where open air is used for cooling. Although a fan is required to be disposed in the rotating device in the case of air cooling, the fan disposed in the rotating device is no longer required because the high-pressure hydrogen gas is supplied to the rotating device.

In addition, the engine has to be warmed up when it is started. Since the hydrogen supplied as fuel in the present invention is supplied to the engine through the rotating device after recovering a part of heat generated by the rotating device, energy required for warming up the engine can be cut in comparison with the case where the hydrogen is supplied to the engine directly from the high-pressure hydrogen tank.

What is claimed is:

1. An automobile driving system comprising:
a hydrogen supply source for supplying hydrogen;
an energy generating source for generating energy to drive an automobile by using, as fuel, the hydrogen supplied from said hydrogen supply source; and
a rotating device for generating or regenerating the automobile driving energy,
wherein at least a part of the hydrogen supplied from said hydrogen supply source is supplied to said energy generating source through said rotating device.

2. An automobile driving system comprising:
a hydrogen supply source for supplying hydrogen;
an energy generating source for generating energy to drive an automobile by using, as fuel, the hydrogen supplied from said hydrogen supply source; and
a rotating device for generating or regenerating the automobile driving energy,
wherein the hydrogen supplied from said hydrogen supply source is supplied to said energy generating source through said rotating device, and said hydrogen supply source is a hydrogen storage unit for storing high-pressure hydrogen gas.

3. The automobile driving system according to claim 1, wherein said energy generating source is a hydrogen engine.

4. The automobile driving system according to claim 1, wherein said energy generating source is a fuel cell.

5. The automobile driving system according to claim 1, wherein said hydrogen supply source comprises a fuel storage unit for storing combustible fuel including fossil fuel and bio fuel, and a hydrogen modifier for converting the combustible fuel to hydrogen.

6. An automobile comprising:
a hydrogen supply source for supplying hydrogen;
wheels;
an energy generating source for generating energy to drive said wheels by using the hydrogen as fuel; and
a rotating device for generating or regenerating the wheel driving energy,
wherein the hydrogen supplied from said hydrogen supply source is supplied to said energy generating source through said rotating device.

7. The automobile according to claim 6, wherein said hydrogen supply source is a hydrogen storage unit for storing high-pressure hydrogen gas.

8. The automobile according to claim 6, wherein said energy generating source is a hydrogen engine.

9. The automobile according to claim 6, wherein said energy generating source is a fuel cell.

10. The automobile according to claim 6, wherein said hydrogen supply source comprises a fuel storage unit for storing combustible fuel including fossil fuel and bio fuel, and a hydrogen modifier for converting the combustible fuel to hydrogen.
